(19) United States
(12) Patent Application Publication
(10) Pub. No.: US 2013/0290947 A1
(43) Pub. Date: Oct. 31, 2013

(54) TERMIMAL AND METHOD FOR UPDATING FIRMWARE OF BASEBOARD MANAGEMENT CONTROLLER

(71) Applicant: Ming Li, Shenzhen City (CN)

(72) Inventor: Ming Li, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/596,065

(22) Filed: Aug. 28, 2012

(30) Foreign Application Priority Data
Apr. 27, 2012 (CN) 201210128384.6

(51) Int. Cl. G06F 9/44

(52) U.S. Cl. 717/171

(57) ABSTRACT

A method applied to a terminal for updating firmware of a BMC in a remote device includes the steps of determining whether each flag file transmitted from the remote controller is a first, a second, or a third flag file, and obtaining a network protocol of a first interface of the terminal, and initializing the same network protocol at a second interface of the remote device. Then assigning an IP address to the second interface when the flag file is determined to be the first flag file and transmitting a firmware updating file to the BMC when the flag file is determined to be the second flag file. A first control signal is generated when the flag file is determined to be the third flag file to direct the BMC to update its own firmware from the firmware updating file.

### BACKGROUND

1. Technical Field

The present disclosure relates to data updating technology, and particularly, to a terminal and a method for updating firmware of a baseboard management controller.

2. Description of Related Art

A baseboard management controller (BMC) is a specialized service processor that periodically monitors a physical state of a remote device, and communications with a host through a system management bus interface. The firmware of the BMC may be updated according to the development and maintenance requirements of the BMC. One method for updating the firmware of the BMC is the BMC receiving a firmware updating file from the host, and then writing the firmware updating file to the BMC.

However, such a method requires a user of the host to keep monitoring the whole firmware updating process, which makes the firmware updating process of the BMC cumbersome and time consuming. For example, the user is required to make sure whether the remote device and the host are connected, and the user is required to make sure whether the firmware updating file has already been transmitted to the BMC.

Therefore, what is needed is a means to solve the problems described above.

### BRIEF DESCRIPTION OF THE DRAWINGS

Many aspects of the present disclosure can be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a schematic diagram of an applied environment of a terminal for updating firmware of a BMC, in accordance with an exemplary embodiment.

FIG. 2 is a block diagram of a system included in the terminal of FIG. 1.

FIG. 3 is a flowchart of a method for updating firmware of a BMC, in accordance with an exemplary embodiment.

### DETAILED DESCRIPTION

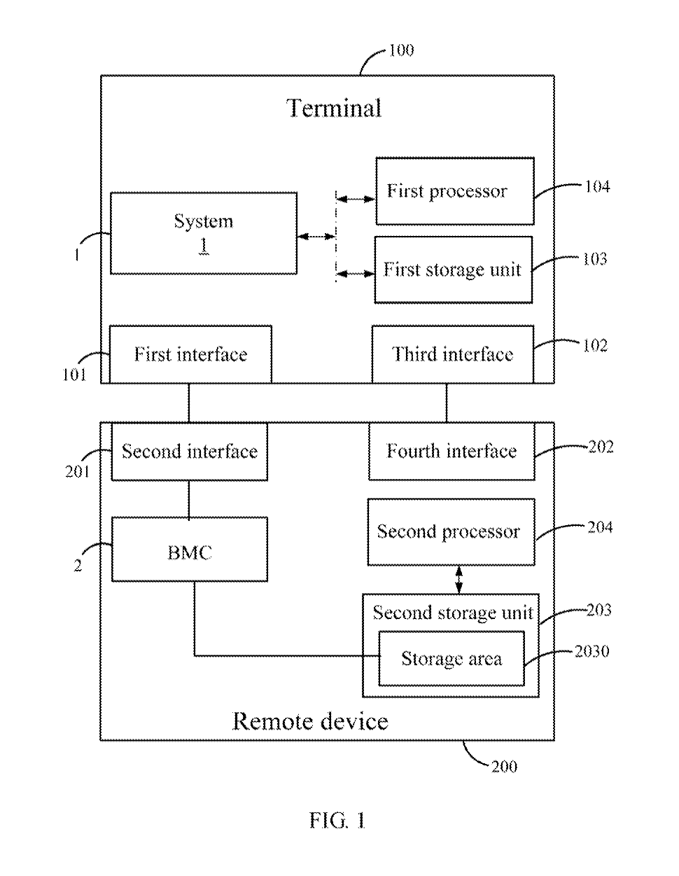

FIG. 1 illustrates an applied environment of a terminal 100 according to an exemplary embodiment. The terminal 100 includes a system 1 configured for updating firmware of the BMC 2 in at least one remote device 200 (FIG. 1 only shows one remote device 200 for the sake of simplicity), and a first processor 104 for performing the function of the system 1. The terminal 100 further includes a first interface 101 and a third interface 102. The remote device 200 includes a second interface 201 and a fourth interface 202. The first interface 101 is connected to the second interface 201, and the second interface 201 is connected to the BMC 2, such that the terminal 100 can transmit or receive data from the BMC 2 when the BMC 2 is booted up. The third interface 102 is connected to the fourth interface 202. In the embodiment, each of the first and the third interfaces 101 and 201 is a LAN port. The remote device 200 further includes a second processor 204 for generating a variety of flag files for indicating different stages of updating the firmware of the BMC 2, and transmitting the generated flag files to the terminal 100 via the third and the fourth interfaces 102, 202, thereby allowing the terminal 100 to control the updating of the firmware of the BMC 2 according to the flag files.

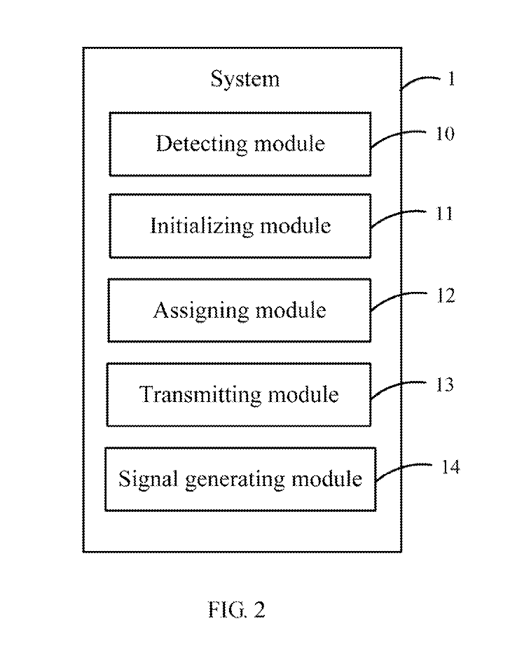

Referring to FIG. 2, in the embodiment, the system 1 includes a detecting module 10, an initializing module 11, an assigning module 12, a transmitting module 13, and a signal generating module 14.

The detecting module 10 detects each flag file received via the second interface 102 of the terminal 100 and determines whether the flag file is a first flag file, a second flag file, or a third flag file. The variety of flag files will be explained.

The initializing module 11 obtains a network protocol of the first interface 101 of the terminal 100, and then initializes the network protocol of the second interface 201 of the remote device 200 according to the obtained network protocol. In the embodiment, the network protocol of the first interface 101 is a Dynamic Host Configuration Protocol (DHCP), and the same network protocol is initialized by the initializing module 11 at the second interface 201. The second processor 204 monitors whether the network protocol of the second interface 201 has already been initialized. If yes, the second processor 204 generates a first flag file and transmits the generated first flag file to the terminal 100 via the fourth and third interfaces 202, 102. In the embodiment, when the initialization of the network protocol of the second interface 201 is finished, the second processor 204 writes data “1” to the flag file, and the flag file including the data “1” generated during the network protocol initializing stage is the first flag file. Otherwise, when the initialization of the network protocol of the second interface 201 is not finished, the second processor 204 writes data “0” to the flag file, and the flag file including the data “0” generated during the network protocol initializing stage is not the first flag file.

The assigning module 12 assigns an IP address to the second interface 201 according to its network protocol when the detecting module 10 determines that the flag file is the first flag file, thereby allowing the terminal 100 and the BMC 2 to communicate with each other after the BMC 2 is booted up. More specifically, during the network protocol initializing stage, the detecting module 10 detects data recorded in the flag file to determine whether the flag file is the first flag file. If the data “1” is detected, the detecting module 10 determines that the flag file is the first flag file, and then informs the assigning module 12 to perform the corresponding function. During the IP address assigning stage, the second processor 204 further monitors whether the IP address of the second interface 201 has already been assigned. If yes, the second processor 203 generates a second flag file and transmits the generated second flag file to the terminal 100 via the fourth and third interfaces 202, 102. In the embodiment, when the assignment of the IP address of the second interface 201 is finished, the second processor 204 writes data “1” to the flag file, and the flag file including the data “1” generated during the IP address assigning stage is the second flag file. Otherwise, when the assignment of the IP address of the second interface 201 is not finished, the second processor 204 writes data “0” to the flag file, and the flag file including the data “0” generated during the IP address assigning stage is not the second flag file.

In the embodiment, the terminal 100 further includes a first storage unit 103. The assigning module 12 assigns the IP address to the second interface 201 according to a configuration table stored in the first storage unit 103. The configuration table includes a variety of IP network segments and at least one assignable IP address associated with each IP network segment. In this case, the assigning module 12 determines the IP network segment applicable to the location of the BMC 2, and then assigns the IP address associated with the determined IP network segment to the second interface 201.

The transmitting module 13 transmits a firmware updating file to the BMC 2 via the first and the second interfaces 101, 201 when the detecting module 10 determines that the flag file is the second flag file. More specifically, during the IP address assigning stage, the detecting module 10 detects data recorded in the flag file to determine whether the flag file is the second flag file. If the data “1” is detected, the detecting module 10 determines that the flag file is the second flag file, and then informs the transmitting module 13 to perform the corresponding function. During the firmware updating file transmitting stage, the second processor 204 further monitors whether the firmware updating file has already been received by the BMC 2. If yes, the second processor 204 generates a third flag file and transmits the generated third flag file to the terminal 100 via the fourth and third interfaces 202, 102. In the embodiment, when the transmission of the firmware updating file is finished, the second processor 204 writes data “1” to the flag file, and the flag file including the data “1” generated during the firmware updating file transmitting stage is the third flag file. Otherwise, when the transmission of the firmware updating file is not finished, the second processor 204 writes data “0” to the flag file, and the flag file including the data “0” generated during the firmware updating file transmitting stage is not the third flag file.

In an alternative embodiment, the remote device 200 further includes a second storage unit 203. If the IP address of the second interface 101 has already been assigned, the second processor 204 further allocates a storage area 2030 of the second storage unit 203 for storing the firmware updating file. After the allocation of the storage area 2030 has been made, the second processor 204 generates a fourth flag file and transmits the generated fourth flag file to the terminal 100 via the fourth and third interfaces 202, 102. In the embodiment, when the allocation of the storage area is finished, the second processor 204 writes data “1” to the flag file, and the flag file including the data “1” generated during the storage area allocating stage is the fourth flag file. Otherwise, when the allocation of the storage area is not finished, the second processor 204 writes data “0” to the flag file, and the flag file including the data “0” generated during the storage area allocating stage is not the fourth flag file. In this case, the detecting module 10 further detects whether the flag file is the fourth flag file. If yes, the transmitting module 13 transmits the firmware updating file to the BMC 2 via the first and the second interfaces 101, 201, and then the received firmware updating file can be stored in the storage area 2030. More specifically, during the storage area allocating stage, the detecting module 10 detects data recorded in the flag file to determine whether the flag file is the fourth flag file. If the data “1” is detected, the detecting module 10 determines that the flag file is the fourth flag file, and then informs the transmitting module 13 to perform the corresponding function.

The signal generating module 14 generates a first control signal and transmits the first control signal to the BMC 2 via the first and the second interfaces 101, 201 when the detecting module 10 determines that the flag file is the third flag file, and the first control signal is configured to direct the BMC 2 to receive the firmware updating file and then update its own firmware by writing the data recorded in the firmware updating file. More specifically, during the firmware updating file transmitting stage, the detecting module 10 detects data recorded in the flag file to determine whether the flag file is the third flag file. If the data “1” is detected, the detecting module 10 determines that the flag file is the third flag file, and then informs the signal generating module 14 to perform the corresponding function.

In an alternative embodiment, the BMC 2 needs to update the firmware at predetermined times. The second processor 203 further monitors whether the BMC 2 has been updated at least once. If yes, the second processor 204 generates a fifth flag file and transmits the fifth flag file to the terminal 100. In the embodiment, when the firmware has been updated at least once, the second processor 204 writes data “1” to the flag file, and the flag file including the data “1” generated during the firmware updating stage is the fifth flag file. Otherwise, when the firmware has not been updated at least once, the second processor 204 writes data “0” to the flag file, and the flag file including the data “0” generated during the firmware updating stage is not the fifth flag file. In this case, during the firmware updating stage, when the detecting module 10 determines that the flag file includes the data “0”, the detecting module 10 determines that the flag file is the fifth flag file, and then informs the signal generating module 14 to generate a second control signal. The second control signal is configured to direct the BMC 2 to repeat the update operation.

In the embodiment, a distinctive file name is assigned to each of the flag files for indicating a different stage of updating the firmware, and the different stages of updating the firmware includes the network protocol initializing stage, the IP assigning stage, the storage area allocating stage, the firmware updating file transmitting stage, and the firmware updating stage. For example, the flag file generated during the network protocol initializing stage is a text file that is named as “ipsource.txt”. During the network protocol initializing stage, the second processor 204 writes data “1” or data “0” to the flag file according to the monitored result that whether the initialization of the network protocol is finished. Then, the second processor 204 transmits the flag file to the terminal 100, and the terminal 100 stores the flag file to the first storage unit 103. In this case, the detecting module 10 periodically obtains the flag file from the first storage unit 103, determines that the flag file was generated during the network protocol initializing stage by reference to its file name “ipsource.txt”, and then analyzes the data recorded in the flag file. If the data value “1” is detected, the detecting module 10 determines that the flag file is the first flag file which indicates that the initialization of the network protocol of the second interface 103 has been achieved.

In the embodiment, when detecting that the flag file is not the first, the second, the third, the fourth, or the fifth flag file, the detecting module 10 continues detecting the flag files stored in the first storage unit 103 until a predetermined time of the detection is reached. Then, the detecting module 10 determines that the firmware updating of the BMC 2 has failed, and the signal generating module 14 generates a third control signal to direct the BMC 2 to stop attempting to update the firmware.

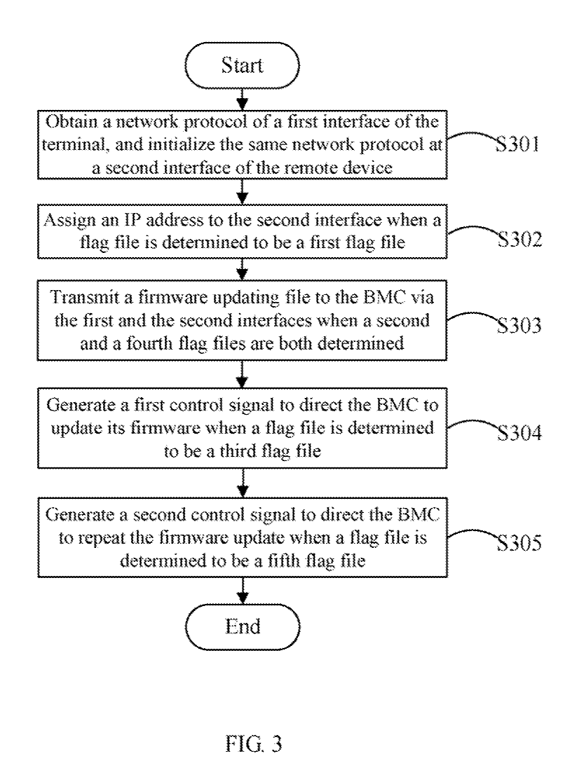

FIG. 3 is a flowchart of a method for updating firmware of a BMC 2 installed in a remote device 200 in accordance with an exemplary embodiment.

In step S301, the initializing module 11 obtains a network protocol of the first interface 101 of the terminal 100, and then initializes the same network protocol at the second interface 201 of the remote device 200.

In step S302, the assigning module 12 assigns an IP address to the second interface 201 according to its network protocol when the detecting module 10 determines that the flag file is the first flag file which indicates that the network protocol of the second interface 201 has already been initialized, thereby allowing the terminal 100 and the BMC 2 to communicate with each other after the BMC 2 is booted up.

In step S303, the transmitting module 13 transmits a firmware updating file to the BMC 2 via the first and the second interfaces 101, 201 when the second and the fourth flag files are both detected by the detecting module 10, wherein the second flag file indicates that the IP address of the second interface 201 has already been assigned, and the fourth flag file indicates that the storage area 2030 for storing the firmware updating file has already been allocated.

In step S304, the signal generating module 14 generates a first control signal and transmits the first control signal to the BMC 2 via the first and the second interfaces 101, 201 when the detecting module 10 determines that the flag file is the third flag file which indicates that the firmware updating file has already been received by the BMC 2, and the first control signal is configured to direct the BMC 2 to receive the firmware updating file in the storage area 2030 of the second storage unit 203 and to update its own firmware by writing the data recorded in the firmware updating file.

In step S305, the signal generating module 14 generates a second control signal and transmits the second control signal to the BMC 2 to direct the BMC 2 to repeat the firmware update when the detecting module 10 determines that the flag file is the fifth flag file.

The present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A terminal configured for updating firmware of a baseboard management controller in a remote device, the terminal comprising:
a first interface connected to a second interface of the remote device, the second interface connected to the baseboard management controller;
a third interface connected to a fourth interface of the remote device;
a detecting module to detect flag files transmitted from the remote controller via the fourth and the third interfaces, and determine whether the flag file is a first flag file, a second flag file, or a third flag file;
an initializing module to obtain a network protocol of the first interface of the terminal, and initialize a network protocol of the second interface of the remote device according to the obtained network protocol;
an assigning module to assign an IP address to the second interface according to the network protocol of the first interface when the detecting module determines that the flag file is the first flag file which indicates that the network protocol of the second interface has already been initialized;
a transmitting module to transmit a firmware updating file to the baseboard management controller via the first and the second interfaces when the detecting module determines that the flag file is the second flag file which indicates that the IP address of the second interface has already been assigned; and
a signal generating module to generate a first control signal and transmit the first control signal to the baseboard management controller via the first and the second interfaces when the detecting module determines that the flag file is the third flag file which indicates that the firmware updating file has already been received by the baseboard management controller, wherein the first control signal is configured to direct the baseboard management controller to update the firmware by writing data recorded in the firmware updating file.

2. The terminal of claim 1, further comprising a first storage unit for storing the flag files transmitted from the remote device.

3. The terminal of claim 2, wherein the first storage unit further stores a configuration table, and the configuration table comprises a plurality of IP network segments and at least one assignable IP address associated with each IP network segment; the assigning module determines the IP network segment applicable to a location of the baseboard management controller, and assigns the IP address associated with the determined IP network segment to the second interface of the remote device.

4. The terminal of claim 2, wherein the detecting module further detects whether a flag file is a fourth flag file which indicates that the remote device has allocated a storage area for storing the firmware updating file, and the transmitting module transmits the firmware updating file to the baseboard management controller when the detecting module determines that the flag file is the fourth flag files.

5. The terminal of claim 4, wherein a distinctive file name is assigned to each of the flag files for indicating a different stage of updating the firmware, and different stages of updating the firmware comprise a network protocol initializing stage, a IP assigning stage, a storage area allocating stage, a firmware updating file transmitting stage, and a firmware updating stage; the detecting module periodically obtains the flag files from the first storage unit, determines in which stage each obtained flag file is according to the name of the flag file, and then analyzes data recorded in the flag file to determine whether the flag file is the first, the second, the third, or the fourth flag files.

6. The terminal of claim 5, wherein the detecting module further detects whether a flag file is a fifth flag file which indicated that the baseboard management controller has been updated at least once during the firmware updating stage in which the firmware of the baseboard management controller needs to be updated for a predetermined times; the signal generating module generates a second control signal when the detecting module determines that the flag file is the fifth flag file, and transmits the second control signal to the baseboard management controller to direct the baseboard management controller to repeat the firmware update.

7. The terminal of claim 5, wherein when the flag file is not the first, the second, the third, or the fourth flag file, the detecting module continues detecting the flag files stored in the first storage unit until a predetermined time of the detection is reached; the detecting module determines that the firmware updating of the baseboard management controller has failed; and the signal generating module generates a third control signal to direct the baseboard management controller to stop attempting to update the firmware.

8. A method for updating firmware of a baseboard management controller in a remote device, the method applied to a terminal, the terminal comprising a first interface connected to a second interface of the remote device and a third interface connected to a fourth interface of the remote device, the second interface connected to the baseboard management controller, the method comprising:
detecting flag files transmitted from the remote controller via the fourth and the third interfaces, and determining whether the flag file is a first flag file, a second flag file, or a third flag file;
obtaining a network protocol of the first interface of the terminal, and initializing a network protocol of the second interface of the remote device according to the obtained network protocol;
assigning an IP address to the second interface according to the network protocol of the first interface when the flag file is determined to be the first flag file which indicates that the network protocol of the second interface has already been initialized;
transmitting a firmware updating file to the baseboard management controller via the first and the second interfaces when the flag file is determined to be the second flag file which indicates that the IP address of the second interface has already been assigned; and
generating a first control signal and transmitting the first control signal to the baseboard management controller via the first and the second interfaces when the flag file is determined to be the third flag file which indicates that the firmware updating file has already been received by the baseboard management controller, wherein the first control signal is configured to direct the baseboard management controller to update the firmware by writing data recorded in the firmware updating file.

9. The method of claim 8, further comprising:
determining whether a flag file is a fourth flag file which indicates that the remote device has allocated a storage area for storing the firmware updating file; and
transmitting the firmware updating file to the baseboard management controller when determining that the flag file is the fourth flag files.

10. The method of claim 9, wherein a distinctive file name is assigned to each of the flag files for indicating a different stage of updating the firmware, and different stages of updating the firmware comprise a network protocol initializing stage, a IP assigning stage, a storage area allocating stage, a firmware updating file transmitting stage, and a firmware updating stage; and the step determining whether the flag file is a first flag file, a second flag file, a third flag file, or a fourth flag file comprises:
determining in which stage each flag file is according to the name of the flag file; and
analyzing data recorded in the flag file to determine whether the flag file is the first, the second, the third, or the fourth flag files.

11. The method of claim 10, further comprising:
determining whether a flag file is a fifth flag file which indicated that the baseboard management controller has been updated at least once during the firmware updating stage in which the firmware of the baseboard management controller needs to be updated for a predetermined times;
generating a second control signal when determining that the flag file is the fifth flag file; and
transmitting the second control signal to the baseboard management controller to direct the baseboard management controller to repeat the firmware update.
